(19) United States
(12) Patent Application Publication
(10) Pub. No.: US 2010/0205041 A1
(43) Pub. Date: Aug. 12, 2010

(54) DETERMINING THE INTEREST OF INDIVIDUAL ENTITIES BASED ON A GENERAL INTEREST

(75) Inventors: Priyang Rathod, Mountain View, CA (US); Simon J. Gibbs, San Jose, CA (US); Anugeetha Kunjithapatham, Sunnyvale, CA (US); Mithun Sheshagiri, Mountain View, CA (US); Phuong Nguyen, San Jose, CA (US)

Correspondence Address: Beyer Law Group LLP/ SISA, P.O. Box 1687, Cupertino, CA, 95015-1687, US

(73) Assignee: SAMSUNG ELECTRONICS CO., LTD., Suwon City (KR)

(21) Appl. No.: 12/370,414

(22) Filed: Feb. 12, 2009

(51) Int. Cl. G06Q 10/00

(52) U.S. Cl. 705/10

(57) ABSTRACT

An interest value indicative of the interest of a particular entity in one or more items can be determined based on a general interest value (e.g., a group interest/preference value) associated with a plurality of entities (e.g., persons, members of a group) that include that particular entity. The interest value can be determined based on Collaborative Filtering (CF) data and/or individual (or non-collaborative) data. In contrast to the Collaborative Filtering (CF) data which may include data associated with various entities, the individual (or non-collaborative) data typically pertains to one entity, namely, the entity whose interest is to be determined. It will be appreciated that both collaborative and non-collaborative data pertaining to individuals can be considered, thereby allowing for a better estimation of individual interests. The interest of a particular entity can be determined, for example, by considering the difference between a predicted CF interest value (determined based on CF data) and a group interest value and/or by considering the difference between a predicted individual interest value (determined based on non-collaborative data) and the group interest value.

### BACKGROUND OF THE INVENTION

Today, digital data is available in numerous forms including multimedia data provided, for example, movies, broadcast television programs, home movies, or user-created video clips. Digital data can be stored in various devices and formats available for consumers. The amount of video media available to the consumers continues to grow at a very high rate. Broadcast, cable, or satellite companies often provide hundreds of different channels for the consumers to choose from. Movie rental companies such as Netflix and Blockbuster have tens, even hundreds, of thousands of titles on DVDs (digital video disc) or video cassettes. More recently, the Internet has facilitated distribution of content media world-wide. Sites such as YouTube have immense video collections, often millions of video clips, contributed by users from all over the world.

Of course, the content of digital data may vary widely. As a result, various rating systems have been developed to help the consumers make informed choices. For example, a star rating system is often used by movie critics and viewers to rate movies or films. For television programs, the Nielsen Ratings is a well-known system that measure audience viewing results. Movie rental companies such as Netflix or Blockbuster and Internet sites such as YouTube or Amazon allow viewers to rate and/or comment on individual movies or video clips manually, such as by selecting a number of stars for each video rated, and these individual ratings are combined or averaged to provide an overall rating for the particular video. These rating systems often reflect the popularity of the videos.

Ratings may be used for different purposes. For example, people may choose to watch a movie based on it star rating. Sponsors, rental companies, or Internet sites may recommend videos based on their ratings. Individuals with similar likes may be offered similar items and/or items selected by one individual can be offered to other individual with similar likes, and so on.

Generally, it is highly useful to know the interest that an individual may have in an item of interest. As such, techniques for determining the interest of individuals are highly useful.

### SUMMARY OF THE INVENTION

Broadly speaking, the invention relates to determining the interest that an entity may have in one or more items (or items of interest) using computing environments and computing systems.

More particularly, the invention pertains to determining the interest of individual entities based on an interest that may be associated with the entities collectively. It will be appreciated that the invention can, for example, be provided for various computing environments and/or computing systems operable to use digital data stored in various forms.

In accordance with one aspect of the invention, an interest value indicative of the interest of a particular entity in one or more items can be determined based on a general interest value (e.g., a group interest value, a group preference value) associated with a plurality of entities (e.g., person, members of a group, an individual) that include that particular entity. It will be appreciated that the interest value can be determined based on Collaborative Filtering (CF) data and/or individual (or non-collaborative) data. In contrast to the Collaborative Filtering (CF) data which may include data associated with various entities, the individual (or non-collaborative) data typically pertains to one entity, namely, the entity whose interest is to be determined.

In accordance with one embodiment of the invention, an interest value indicative of the interest of a particular entity can be determined based on one or more estimated (or predicted) interest values. The one or more estimated (or predicted) interest values can include a Collaborative Filtering (CF) interest value determined based on Collaborative Filtering (CF) data using a Collaborative Filtering (CF) scheme. In addition or alternatively, one or more individually-based interest values can be determined based on individual (or non-collaborative) data. The individually-based interest values can, for example, be determined based on content-based or non-content-based data including, for example, profile data (e.g., age, gender), usage data (e.g., number of hours spent by a particular individual to watch TV), and various other data (e.g., data pertaining likes and/or dislikes of a particular user with respect to specific types of content, such as, for example, “horror” movies, “rock” music,” and so on)) that may be available. The interest value indicative of the interest of a particular individual can, for example, be determined by effectively comparing the one or more estimated (or predicted) interest values with the general interest value associated with the plurality of entities that include that particular entity. By way of example, the respective difference of each one of the one or more estimated interest values to the general interest value can be determined as one or more prediction errors. One or more prediction errors can be used to determine the interest of a particular individual. As such, given a numerical general interest value of three (3) and corresponding collaboratively-based interest value of “4.8” and individually-based interest value of “5.5”, two differences (or prediction errors) can be determined, namely, a first difference: “1.8” (4.8-3) and a second difference: “2.5” (5.5-3). The first and the second differences can be used to determine an estimated interest value indicative of the interest of the individual based on the general interest value of three (3) as will be known to those skilled in the art. For example, the average of differences can be determined to be “2.15” (2.5+1.8/2) and used to assess the likelihood that the general interest value is reflective of the individual's interest (e.g., 10% probability) and/or estimate the interest of the individual (e.g., determine the interest of the individual to be “4.3”, a value significantly higher that the general interest value).

The invention can be implemented in numerous ways, including, for example, a method, an apparatus, a computer readable (and/or storable) medium, and a computing system (e.g., a computing device). A computer readable medium can, for example, include at least executable computer program code stored in a tangible form. Several embodiments of the invention are discussed below.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, wherein like reference numerals designate like structural elements, and in which:

FIG. 1A depicts a computing system in accordance with one embodiment of the invention.

FIG. 1B depicts a method for determining an interest value indicative of the interest of an entity in one or more items in accordance with one embodiment of the invention.

FIG. 2A depicts a computing system in accordance with another embodiment of the invention.

FIG. 2B depicts a method for determining the interest of a member of a group based on a group interest value in accordance with another embodiment of the invention.

FIG. 2C depicts a method for determining the interest of a member of a group based on a group interest value in accordance with another embodiment of the invention.

### DETAILED DESCRIPTION OF THE INVENTION

As noted in the background section, generally, it is highly useful to know the interest of individuals in various items of interest. As such, techniques for determining the interest of individuals can be highly useful.

In some situations, a general interest associated with a plurality of entities may be known. By way of example, a general interest (or preference) value for a group may be known as a numerical value (e.g., three (3) in a range of one (1) to five (5)). This general interest value may be provided by only one of the members of the group and can reflect the actual and/or expressed interest of the member in one or more items. However, the general interest value may be provided in an anonymous manner without identifying the member of the group which has actually provided the interest value. For example, a general interest value (e.g., an interest rating) can be associated with a family including a father, a mother, and two children of various ages. Any one the members of the family can rate a program viewed on Television and provide the rating for the family without having to identify themselves as the father, mother, or one of the children. In such situations, it would be useful to have the ability to make an assessment regarding the interest of each member of the family based on the general interest.

More generally, individual identity of various entities may not be always known even though a general rating associated with them may be known. Also, it is generally desirable to allow individuals to express their interest anonymously in order to protect their identity. As such, it would be useful to determine the interest of an individual entity based on a general interest that may be loosely associated with that particular entity.

The invention pertains to determining the interest of individual entities based on an interest that may be associated with the entities collectively. It will be appreciated that the invention can, for example, be provided for various computing environments and/or computing systems operable to use digital data stored in various forms.

In accordance with one aspect of the invention, an interest value indicative of the interest of a particular entity in one or more items can be determined based on a general interest value (e.g., a group interest value, group preference value) associated with a plurality of entities (e.g., person, members of a group, an individual) that include that particular entity. It will be appreciated that the interest value can be determined based on Collaborative Filtering (CF) data and/or individual (or non-collaborative) data. In contrast to the Collaborative Filtering (CF) data which may include data associated with various entities, the individual (or non-collaborative) data typically pertains to one entity, namely, the entity whose interest is to be determined.

In accordance with one embodiment of the invention, an interest value indicative of the interest of a particular entity can be determined based on one or more estimated (or predicted) interest values. The one or more estimated (or predicted) interest values can include a Collaborative Filtering (CF) interest value determined based on Collaborative Filtering (CF) data using a Collaborative Filtering (CF) scheme. In addition or alternatively, one or more individually-based interest values can be determined based on individual (or non-collaborative) data. The individually-based interest values can, for example, be determined based on content-based or non-content-based data including, for example, profile data (e.g., age, gender), usage data (e.g., number of hours spent by a particular individual to watch TV), and various other data (e.g., demographic data) that may be available. The interest value indicative of the interest of a particular individual can, for example, be determined by effectively comparing the one or more estimated (or predicted) interest values with the general interest value associated with the plurality of entities that include that particular entity. By way of example, the respective difference of each one of the one or more estimated interest values to the general interest value can be determined as one or more prediction errors. One or more prediction errors can be used to determine the interest of a particular individual. As such, given a numerical general interest value of there (3) and corresponding collaboratively-based interest value of “4.8” and individually-based interest value of “5.5”, two differences (or prediction errors) can be determined, namely, a first difference: “1.8” (4.8-3) and a second difference: “2.5” (5.5-3). The first and the second differences can be used to determine an estimated interest value indicative of the interest of the individual based on the general interest value of there (3) as will be known to those skilled in the art. For example, the average of differences can be determined to be “2.15” (2.5+1.8/2) and used to assess the likelihood that the general interest value is reflective of the individual's interest (e.g., 10% probability) and/or estimate the interest of the individual (e.g., determine the interest of the individual to be “4.3”, a value significantly higher that the general interest value).

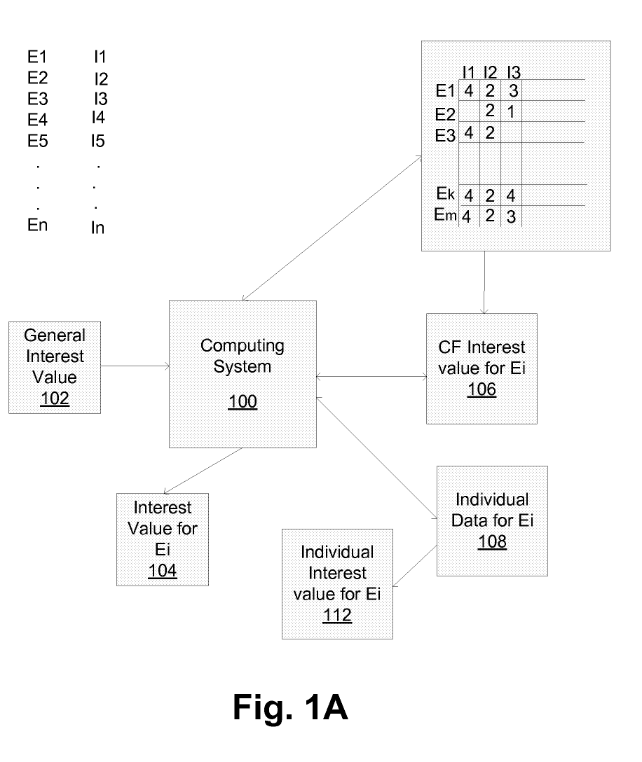

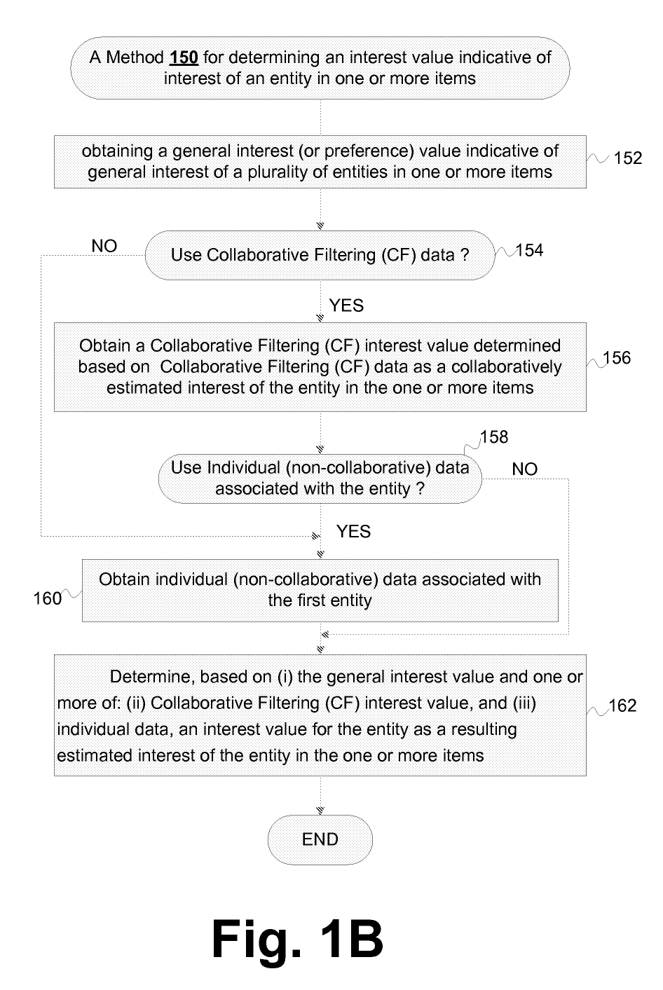

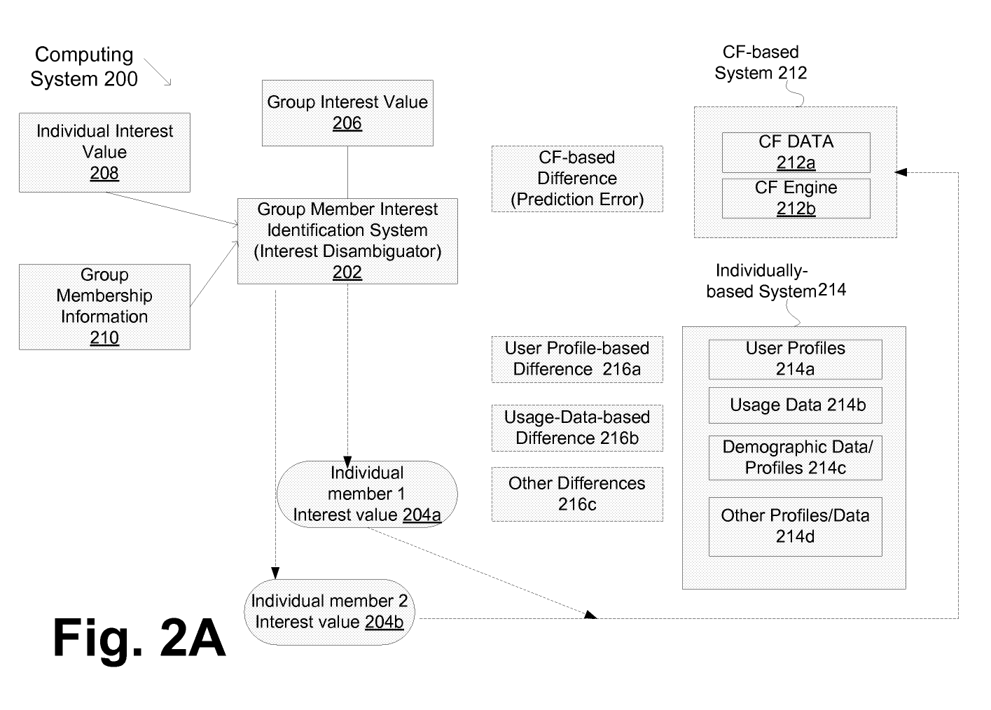

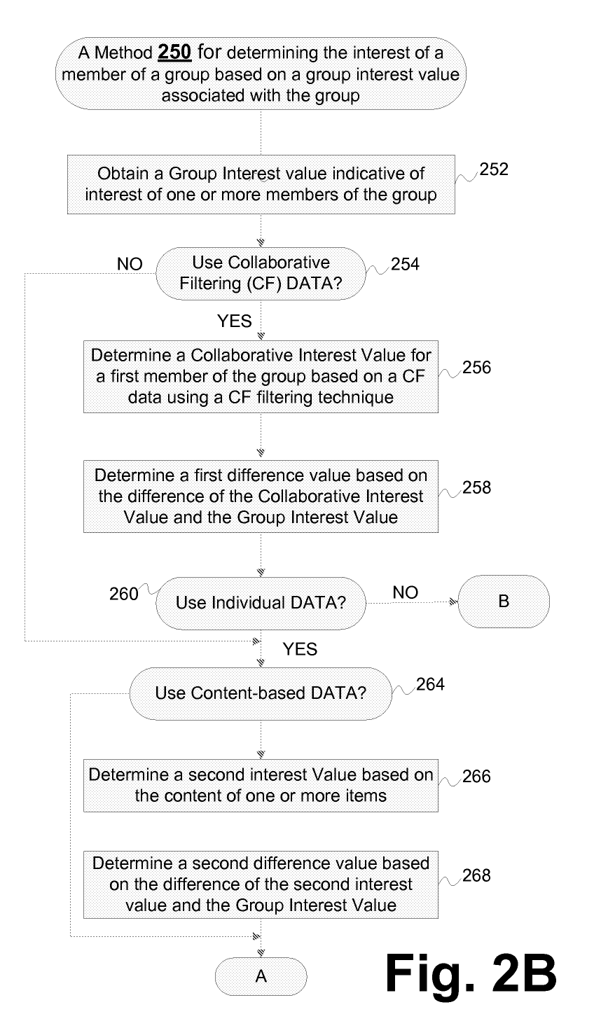

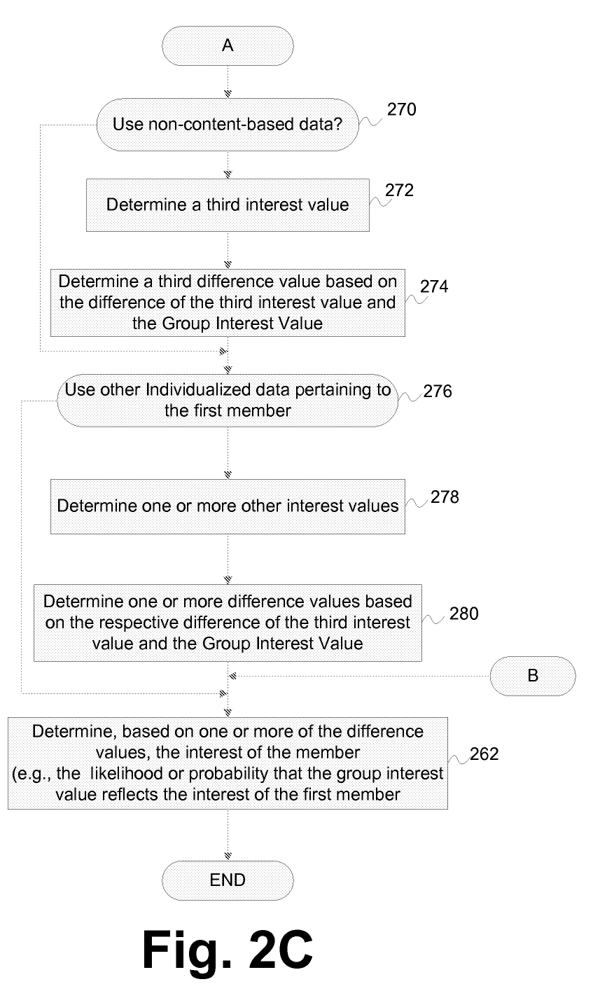

Embodiments of these aspects of the invention are discussed below with reference to FIGS. 1A-2C. However, those skilled in the art will readily appreciate that the detailed description given herein with respect to these figures is for explanatory purposes as the invention extends beyond these limited embodiments.

FIG. 1A depicts a computing system 100 in accordance with one embodiment of the invention. Those skilled in the art will readily appreciate that the computing system 100 can, for example, include one or more processors, memory, executable computer code stored in a computer readable storage medium (not shown).

Referring to FIG. 1A, the computing system 100 can be operable to obtain a general interest (or preference) value 102 indicative of general interest of a plurality of entities (E₁-Eₙ) in one or more items of interest (I₁-Iₙ). An individual entity Eᵢ can, for example, be a person, company, organization, end user.

An item of interest Iᵢ can, for example, be one or more media items, one or more applications, one or more audio files, one or more video files, one or more songs, one or more movies, and so on. Typically, the general interest value 102 can be loosely associated with one or more of the entities (E₁-Eₙ) and it represents the actual and/or expressed interest of one or more of the entities (E₁-Eₙ). However, the one or more entities can be anonymous with respect to their actual and/or expressed interest. By way of example, the general interest value 102 can be a general interest value associated with first, second and third entities (E₁, E₂ and E₃) represented by a first group (G1). Furthermore, the general interest value 102 can, for example, be indicative of the expressed interest of a particular one of the entities in one or more items of interest. By way of example, the general interest value 102 can be indicative of the actual and/or expressed interest of a second entity (E₂) in a third item of interest (I₃). However, the general interest value 102 can be received anonymously as a general (or ambiguous) interest value associated with the first group (G1) including the first, second and third entities (E₁, E₂ and E₃).

It will be appreciated that the computing system 100 can determine an interest value 104 for an entity E₁ based on the general interest value 102. The interest value 104 indicative of the interest of a particular entity Eᵢ can, for example, be expressed as the likelihood and/or probability that the general interest value 102 is indicative of the particular entities' (Eᵢ's interest). By way of example, when the general interest value 102 is obtained as a general interest value associated with a group of entities including the first, second and third entities (E₁, E₂ and E₃), the interest value 104 for the first, second and third entities (E₁, E₂ and E₃) can, for example, be expressed as a probability (e.g., 10% probability that the general interest value 102 is indicative of the interest of the first entity E₁, 75% probability that the general interest value 102 is indicative of the interest of the second entity E₂ and 15% probability that the general interest value 102 is indicative of the interest of the third entity E₃). It should be noted that the interest value 104 determined for a particular entity 104 can be expressed in many different forms including, for example, an estimated interest value. As such, if the general interest value 102 is expressed as a numerical (e.g., “4” in a range of “0-6”) the interest value 104 can be expressed as a numerical for each one of the entities associated with the general interest value 102.

As noted above, the computing system 100 can determine the interest value 104 as a particular or specific interest value for a particular entity Eᵢ based on a general interest value 102 associated with a plurality of entities including the entity Eᵢ. It should be noted that the computing system 100 can also obtain a Collaborative Filtering (CF) interest value 106 and individual data 108 for an entity Eᵢ. Moreover, the computing system 100 can determine the interest value 104 for a particular entity Eᵢ based on the CF interest value 106 and/or individual data 108 for the entity Eᵢ. It will be appreciated that CF interest value 106 can represent a Collaborative Filtering (CF) interest value determined based on a Collaborative Filtering (CF) technique as a collaboratively estimated interest of a particular entity Eᵢ in one or more items of interest (I₁-Iₙ), as will be known to those skilled in the art. The CF interest value 106 can be determined based on CF data 110. FIG. 1A depicts simplified CF data for a group of entities. Referring to FIG. 1A, the collaborative interest value for a third entity E₃ can be determined based on data associated with the interest of other entities, namely the first entity E₁ and entities E_{K} and E_{M}. By way of example, the CF interest value for the third entity (E₃) in the third item I₃ can be determined as an estimated CF interest value of “3.3” as an average of the known interests of the individuals which are believed to have similar interests as the third entity E₃.

It should be noted that the computing system 100 can be operable to determine the CF interest value 106 based on the CF data 110 and/or obtain the CF interest value 106 as input. In addition to the CF interest value 106, the computing system 100 can also use the individual data 108 pertaining to a particular entity Eᵢ in order to determine the interest value for that particular entity as an interest value 104. In contrast to the CF interest value 106 determined based on the CF data 110, an estimated individual interest value 112 can be determined based on the individual data 108 representing non-collaborative data or data specifically pertaining to a particular entity Eᵢ. In other words, the computing system 100 can be operable to utilize both collaborative data and non-collaborative (or individualized data) in order to determine the interest value 104 based on a general interest value 102.

Generally, the individual data 108 pertaining to an individual entity Eᵢ can include one or more known properties, characteristic and/or attributes of the entity. The individual data 108 can, for example, include content-based data and non-content based data. The content-based data can be indicative of one or more attributes and/or factors that can be considered in view of content of one or more items of interest I₁-Iₙ in order to make an assessment regarding the interest of a particular individual Iᵢ with respect to the one or more items of interest given the general interest value 102. In contrast, non-content based data can be indicative of one or more attributes and/or factors that can be considered regardless of content of the one or more items of interest (I₁-Iₙ) in order to make an assessment regarding the interest of a particular entity Iᵢ with respect to the one or more items of interest (I₁-Iₙ).

As noted above, the individual data 108 can be used to effectively determine an estimated individual interest value 112 for a particular entity Eᵢ. The computing system 100 can be operable to effectively consider an individual interest value 112 and/or a CF interest value 106 in order to determine the interest value 104 given a general interest value 102. As a result given a general interest value 102, CF data 110 and/or individual data 108 can be effectively used by the computing system 100 in order to determine an individual interest value 104 for a particular individual Eᵢ expressed in various forms.

The computing system 100 can, for example, be operable to determine the interest value 104 for a particular entity Eᵢ based on the difference of the CF interest value 106 and the general interest value 102 and/or the difference between the general interest value 102 and an estimated individual interest value 112 determined based on the individual data 108.

It should be noted that the interest value 104 can be provided as CF data 110, thereby effectively providing feedback based on an estimated interest value. It should also be noted that the interest value 104 can be effectively marked in the CF data 110 in order to identify it as an interest value that has been provided as an estimation of interest rather than an interest value that may reflect a real and/or expressed interest or determined based on other data.

Furthermore, it will be appreciated that the interest value 104 can be used for various applications including making recommendations with respect to one or more items of interest.

FIG. 1B depicts a method 150 for determining an interest value indicative of the interest of an entity in one or more items in accordance with one embodiment of the invention. The method 150 can, for example, be used by the computing system 100 depicted in FIG. 1A. Referring to FIG. 1B, initially, a general interest (or preference value) is obtained (152). The general interest value can be indicative of general interest of a plurality of entities in one or more items. By way of example, the general interest value can be associated with multiple persons and/or individuals that may be represented in a group (e.g., a family, an organization). Referring to FIG. 1B, it is determined (154) whether to use Collaborative Filtering (CF) data. If it is determined (154) to use Collaborative Filtering (CF) data, a first Collaborative Filtering (CF) interest value is obtained (156). Generally the CF interest value can be determined based on Collaborative Filtering (CF) data using one or more Collaborative Filtering (CF) techniques, as will be understood by those skilled in the art. As such, the Collaborative Filtering (CF) interest value can represent a collaboratively estimated interest of a particular entity in one or more items. After the CF interest value is determined (156), it is determined whether to additionally use individual (non-collaborative) data in order to determine the interest value for the entity. In other words, it is determined (158) whether to additionally use individual data associated with the entity. If it is determined (158) to use individual data, individual data associated with the entity is obtained (160). On the other hand, if it is determined (154) not to use Collaborative Filtering (CF) data, the method 150 proceeds to obtain the individual data associated with the entity (160). In other words, at least one of the Collaborative Filtering (CF) data and individual (non-collaborative) data is used in order to determine an interest value for the entity based on the general interest value (162). The method 150 ends after an interest value for the entity is determined (162) as a resulting estimated interest of the entity in the one or more items.

FIG. 2A depicts a computing system 200 in accordance with another embodiment of the invention. It will be appreciated that the computing system 200 can, for example, be provided as a computing device (e.g., a personal computer, a server, a mobile device, a mobile phone, a laptop). Referring to FIG. 2A, a computing system 200 includes a group member identification (or interest/preference Disambiguator) system (or component) 202 operable to determine interest values 204 for individuals (e.g., 204a and 204b) based on a group interest value 206. It should be noted that the group member identification system 202 can also be operable to obtain additional information including individual interest values 208 for individual members associated with various group and group membership information including data that effectively identifies an individual as a part of one or more groups.

Referring to FIG. 2A, CF-based system 212 and individually-based system 214 are also depicted as a part of the computing system 200. The CF-based system 212 can include CF data 212a and a CF engine 212b operable to effectively provide a CF-based difference (or prediction error) indicative of the difference between a predicted CF-based interest value for a particular member (or individual) and the group interest value 206. An individually-based system 214 can include various content-based and non-content based data including user profiles 214a, usage data 214b, demographic data/profiles 214c and various other profiles/data 214d pertaining to an individual member. As such, the individually-based system 214 can be operable to provide various individually-based differences (or prediction errors) including a user profile-based difference 216a, a usage-data difference 216b, as well as other differences 216c determined based on other types of individual data 214. A group member interest identification system 202 can obtain one or more of the differences (or prediction errors) including the CF-based difference 215 and the individually based differences 216 in order to determine an interest value 204 for individual members of the group.

It should be noted that the individual interest values 204 can be provided as effective feedback to the CF based system 212 and/or individually-based system 214 and effectively marked accordingly.

FIGS. 2B and 2C depict a method 250 for determining the interest of a member of a group based on a group interest value in accordance with another embodiment of the invention. The method 250 can, for example, be used by the group member interest identification system 202 depicted in FIG. 2A.

Referring to FIG. 2B, initially, a group interest value is obtained (252). Typically, the group interest value is indicative of the interest of one or more members of the group. However, a group interest value can effectively be provided in an anonymous manner. As such, the identity of the member who may have actually expressed the interest may not be known even though it is known that the member is part of the group as other information pertaining to the member may be known. Referring back to FIG. 2B, it is determined (254) whether to use Collaborative Filtering (CF) data. As such, a Collaborative Filtering (CF) interest value can be determined (256) for a member of a group based on the Collaborative Filtering (CF) data using a Collaborative Filtering (CF) technique. Next, a first difference value (or prediction error) can be determined (258) based on the difference of the first Collaborative Filtering (CF) interest value and the group interest value. Thereafter, the method 250 can proceed to determine (260) whether to use individual data pertaining to the member. If it is determined (260) not to additionally use individual data, the method 250 can proceed to determine the interest of the member solely based on the Collaborative Filtering (CF) data. By way of example, the likelihood and/or probability that the group interest value reflects the interest of the member can be determined before (262) the method 250 ends.

However, if it is determined (260) to use individual data, it is determined (264) whether to use content-based data and a second interest value can be determined based on the content of the more items of interest in order to determine a second difference value on the difference of the second interest value and the group interest value.

Referring now to FIG. 2C, it can also be determined (270) whether to use non-content based data and a third interest value can be determined (272) based on non-content based data in order to determine (272) a third difference value based on the difference of the third interest value and the group interest value. Additionally, it can be determined (276) whether to use other individualized data pertaining to the first member of the group and one or more interest values can be determined (278) in order to determine one or more other difference values by effectively comparing the one or more interest values to the group interest value.

It should be noted that if it is determined (254) not to use Collaborative Filtering (CF) data, the method 250 proceeds to use at least content-based data, non-content based data (262) or other individual data pertaining to the first member in order to determine (262) the interest of the member.

Generally, the interest of a member can be determined based on one or more of the difference values noted above. Content-based data includes one or more of the following: a profile of said person, a profile of said person that includes his or her age, occupation, state and/or country of residence, address, and a phone number. A recommendation regarding one or more items can be made to an entity based on the determined interest of that entity.

As noted above, the techniques described above can be effectively combined by various other techniques related to rating content.

For example, the techniques of the invention can be effectively combined the techniques described in U.S. patent application Ser. No. 12/120,217 entitled: “SYSTEM AND METHOD FOR AUTOMATICALLY RATING VIDEO CONTENT” (SISAP022) filed on May 13, 2008 which is hereby incorporated by reference herein in its entirety and for all purposes.

More particularly, a rating system can automatically determines the content ratings of the videos that have been operated on a media device in the sense that users of the media device are not required to take any specific actions to rate these videos, such as in the case of, for example, Netflix, YouTube, or Amazon, where users need to manually select a rating level for each video. Instead, with the rating system described above, the device usage actions are monitored and used to adjust the video content ratings in reference to the rating rules without requiring user actions with respect to the rating process. The device usage actions are actions associated with performing video operations on the media device, not rating the video content. Rating rules may be added, modified, or deleted as needed. Different rules may be designed for different types of media devices according to the types of video operations they support.

An automatic rating system may, for example, be used to help provide personalized video content to users of various types of consumer devices, such as televisions, video recorders, cable or set top boxes, and portable media players. System and methods for providing personalized video content are described in more detail in U.S. patent application Ser. No. 12/120,203 (Attorney Docket No. SISAP021/CSL07-NW14-A), entitled “PERSONALIZED VIDEO SYSTEM” by Gibbs et al., filed on May 13, 2008 which is hereby incorporated by reference herein in its entirety and for all purposes. Video content ratings obtained from a specific consumer electronic device can, for example, be used by a video content provider server to rank the pieces of video content selected for the user(s) of that consumer electronic device so that the selected pieces of video content are presented to the user(s) based on their ranks.

Techniques for ranking pieces of video content for individual users is described in more detail in U.S. patent application Ser. No. 12/120,211 (Attorney Docket No. SISAP035/CSL07-NW16), filed on May 13, 2008, entitled “COMBINATION OF COLLABORATIVE FILTERING AND CLIPRANK FOR PERSONALIZED MEDIA CONTENT RECOMMENDATION” by Nemeth et al. and co-pending U.S. patent application Ser. No. 12/120,209 (Attorney Docket No. SISAP036/CSL07-NW17), filed on May 13, 2008, entitled “CLIPRANK: RANKING MEDIA CONTENT USING THEIR RELATIONSHIPS WITH END USERS” by Rathod et al., both of which are hereby incorporated by reference in their entireties and for all intents and purposes. According to some embodiments, the video content ratings obtained from a specific consumer electronic device are used obtain personalized ClipRank on a set of video content for the user(s) of that consumer electronic device.

The various aspects, features, embodiments or implementations of the invention described above can be used alone or in various combinations. The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. In a computing system, a computer-implemented method of determining a first interest value indicative of interest of a first entity in one or more items based on a general interest value associated with a plurality of entities that include said first entity, said computer-implemented method comprising:
obtaining a general interest value indicative of general interest of one or more of said plurality of entities in said one or more items of interest;
obtaining one or more of: (a) a first Collaborative Filtering (CF) interest value determined based on a Collaborative Filtering (CF) data as a collaboratively estimated interest of said first entity of said plurality of entities in said one or more items of interest, and (b) first individual data associated with said first entity;
determining, based on (i) said general interest value and one or more of:
(ii) said first Collaborative Filtering (CF) interest value, and (iii) said first individual data, said first interest value as a resulting estimated interest of said first entity in said one or more items; and
storing said general interest value in a computer readable storage medium.

2. The computer-implemented of claim 1, wherein said computer-implemented method further comprises:
determining a first difference value based on the difference of said general interest value and said first Collaborative Filtering (CF) interest value; and
determining said first interest value at least partially based on said first difference value.

3. The computer-implemented of claim 1, wherein said computer-implemented method comprises:
determining, based on first individual data, a first individual interest value as an individually-based estimate of said first entity's interest in said one or more items;
determining a second difference value based on the difference of said general interest value and said first individual interest value; and
determining said first interest value at least partially based on said first individual interest value and/or said second difference value.

4. The computer-implemented of claim 1, wherein said computer-implemented method comprises:
determining a first difference value based on the difference of said general interest value and said first Collaborative Filtering (CF) interest value;
determining, based on first individual data, one or more individual interest values as one or more individually-based estimates of said first entity's interest in said one or more items;
determining one or more individually-based difference values based on the respective differences of said one or more individual interest values and said general interest value; and
determining first interest value based on said first difference value and said one or more individually-based difference values.

5. The computer-implemented of claim 1, wherein said first interest value includes and/or is indicative of one or more of the following:
likelihood and/or probability that said general interest value is indicative of said first entity's interest;
likelihood and/or probability that said first entity is responsible for said general interest value obtained as an anonymous and/or ambiguous interest and/or preference with respect to said one or more items;
probability that said general interest value is indicative of said first entity's interest;
likelihood that said first entity is responsible for providing said general interest value when said general interest value is obtained as an anonymous and/or ambiguous interest and/or preference value with respect to said one or more items; and
an estimated interest value as a numerical value in a possible range of numerical values as an estimate of interest of said first entity in said one or more items.

6. The computer-implemented of claim 1, wherein said general interest value is indicative of interest of one or more particular entities of said plurality of entities but said one or more particular entities have expressed said interest anonymously.

7. The computer-implemented of claim 1, wherein said general interest value is and/or includes one or more of the following:
an actual interest;
an actual interest expressed by said particular entity;
an estimated interest; and
an interest value effectively provided by said particular entity.

8. The computer-implemented of claim 1, wherein said general interest value is representative of a group interest associated with a group that includes said plurality of entities as group members.

9. The computer-implemented of claim 1, wherein said first individual data includes one or more known properties, characteristics and/or attributes of said first entity.

10. The computer-implemented of claim 1, wherein said obtaining of said first Collaborative Filtering (CF) interest value comprises:
determining said first Collaborative Filtering (CF) interest value based on a Collaborative Filtering (CF) technique.

11. The computer-implemented of claim 10, wherein said determining of said first Collaborative Filtering (CF) interest value determines said first collaborative-interest value for said first individual based on interest values of one or more other entities not included by said plurality of entities.

12. The computer-implemented method of claim 1, wherein said plurality of entities are members of a group.

13. The computer-implemented method of claim 1, wherein said first individual data includes one or more of the following:
content-based data indicative of one or more attributes and/or factors that can be considered in view of content of said one or more items to make an assessment regarding interest of said individual in said one or more items; and
non-content based data indicative of one or more attributes and/or factors that can be considered regardless of content of said one or more items to make an assessment regarding interest of said individual in said one or more items.

14. The computer-implemented method of claim 13,
wherein said first individual is a person, and
wherein said content-based data includes one or more of the following:
a profile of said person, a profile of said person that includes his or her age, occupation, state and/or country of residence, address, and a phone number;
wherein said non-content based data includes usage data indicative of usage of said first person with respect to a system associated with said general interest.

15. The computer-implemented method of claim 1, wherein said method computer-implemented further comprises:
storing said first interest value in Collaborative Filtering data as an estimate of interest of said first individual, thereby effectively providing said first interest value as feed back to enhance said Collaborative Filtering data allowing for more accurate estimations.

16. The computer-implemented method of claim 15, wherein said computer-implemented method further comprises:
effectively marking said first interest value in Collaborative Filtering data as data that has been provided as an estimation of interest of said first individual in said one or more items, thereby allowing distinguishing said first interest value from one or more interest values that are reflective of real and/or expressed interests.

17. The computer-implemented method of claim 16, wherein said computer-implemented method further comprises:
making a recommendation based on said first interest value.

18. The computer-implemented method of claim 17, wherein said making of a recommendation comprises making a recommendation to said first entity regarding one or more items as one or more recommended items.

19. The computer-implemented method of claim 18, wherein said one or more recommended items include one or more of the following:
one or more media items, one or more audio files, one or more video files, one or more songs, one or more movies, and one or more applications.

20. The computer-implemented method of claim 1, wherein said one or more items include one or more of the following: one or more media items, one or more audio files, one or more video files, one or more songs, one or more movies, and one or more applications.

21. A computing system, wherein said computing system is operable to:
obtain a general interest value indicative of general interest of one or more entities of a plurality of entities in one or more items of interest;
obtain one or more of: (a) a first Collaborative Filtering (CF) interest value determined based on a Collaborative Filtering (CF) data as a collaboratively estimated interest of a first entity of said plurality of entities in said one or more items of interest, and (b) first individual data associated with said first entity; and
determining, based on (i) said general interest value and one or more of:
(ii) said first Collaborative Filtering (CF) interest value, and (iii) said first individual data, a first interest value as a resulting estimated interest of said first entity in said one or more items.

22. A computer readable storage medium storing at least executable computer code in a tangible form for determining a first interest value indicative of interest of a first entity in one or more items based on a general interest value associated with a plurality of entities that include said first entity, wherein said computer readable storage medium comprises:
executable computer code operable to obtain a general interest value indicative of general interest of one or more of said plurality of entities in said one or more items of interest;
executable computer code operable to obtain one or more of: (a) a first Collaborative Filtering (CF) interest value determined based on a Collaborative Filtering (CF) data as a collaboratively estimated interest of said first entity of said plurality of entities in said one or more items of interest, and (b) first individual data associated with said first entity;
executable computer code operable to determine, based on (i) said general interest value and one or more of: (ii) said first Collaborative Filtering (CF) interest value, and (iii) said first individual data, said first interest value as a resulting estimated interest of said firs entity in said one or more items.
